(19) United States
(12) Patent Application Publication
(10) Pub. No.: US 2009/0095286 A1
(43) Pub. Date: Apr. 16, 2009

(54) Cereal Refining Process

(76) Inventors: John Kerr, South Croydon (GB); Robert Jansen, Portela (PT); Loren Luppes, Estero, FL (US); Peter Lloyd-Jones, Loudon, TN (US); Richard Tanner, Roydon (GB)

Correspondence Address: WILLIAMS, MORGAN & AMERSON, 10333 RICHMOND, SUITE 1100, HOUSTON, TX, 77042, US

(21) Appl. No.: 12/173,257

(22) Filed: Jul. 15, 2008

Related U.S. Application Data
(60) Provisional application No. 61/023,203, filed on Jan. 24, 2008.
(60) Provisional application No. 60/953,799, filed on Aug. 3, 2007.

(51) Int. Cl. C08B 30/00

(52) U.S. Cl. 127/68

(57) ABSTRACT

A process including steeping cereal kernels in an aqueous liquid, producing softened cereal; milling the softened cereal, producing a milled cereal comprising germ, protein, starch, and fiber; separating at least some of at least one material selected from the group consisting of germ, starch, and protein from the milled cereal, producing at least one of germ, starch, and a first protein portion, and also producing a first fiber portion that comprises fiber and starch, and a light steep water that comprises protein; separating at least some protein from the light steep water, producing a second protein portion and a process water that comprises protein; converting at least some of the starch in the first fiber portion to saccharides; separating at least some of the saccharides from the first fiber portion, producing saccharides and a second fiber portion that comprises fiber; and burning at least some of the fiber from the second fiber portion, producing a flue gas and a first quantity of energy; wherein the process further comprises at least one step selected from the group consisting of least partially powering at least one previous step with the first quantity of energy; and drying at least one separated material selected from the group consisting of the germ, the starch, the first protein portion, the second protein portion, and the saccharides with the flue gas, producing a dried separated material and a dryer exhaust. In one further embodiment, the process further includes digesting anaerobically the biologically available organic residues from the process water, producing a biogas and a final waste water. In a still further embodiment, the process further includes burning the biogas to produce a second quantity of energy and at least partially powering at least one previous step with the second quantity of energy.

This application claims priority from U.S. application 60/953,799, which was filed on Aug. 3, 2007, and U.S. application 61/023,203, which was filed on Jan. 24, 2008, both of which are incorporated herein by reference.

### BACKGROUND OF THE INVENTION

Cereal kernels, such as corn or wheat, contain starch, protein, fiber, and other substances which can be separated to make various useful products. Such a separation process is generally referred to as “cereal refining.”

### SUMMARY OF THE INVENTION

In one embodiment, the present invention relates to a process including steeping cereal kernels in an aqueous liquid, producing softened cereal; milling the softened cereal, producing a milled cereal comprising germ, protein, starch, and fiber; separating at least some of at least one material selected from the group consisting of germ, starch, and protein from the milled cereal, producing at least one of germ, starch, and a first protein portion, and also producing a first fiber portion that comprises fiber and starch, and a light steep water that comprises protein; and burning at least some of the fiber, producing a flue gas and a first quantity of energy; wherein the process further comprises at least one step selected from the group consisting of least partially powering at least one previous step with the first quantity of energy; and drying at least one separated material selected from the group consisting of germ, starch, protein, and saccharides with the flue gas, producing a dried separated material and a dryer exhaust.

In one further embodiment, the process further includes digesting anaerobically biologically available organic residues from the process water or saccharides produced by saccharification of starch, producing a biogas and a final waste water. In a still further embodiment, the process further includes burning the biogas to produce a second quantity of energy and at least partially powering at least one previous step with the second quantity of energy. In a further embodiment, valuable co-products are recovered from the wastewater and/or the ash that is produced when the fiber is burned.

### BRIEF DESCRIPTION OF THE DRAWINGS

FIG. 1 is a process flow diagram of one embodiment of the invention.

FIG. 2 is a process flow diagram of another embodiment of the invention.

FIG. 3 compares the production of dextrose over time during starch liquefaction between two alpha-amylase enzymes.

### DESCRIPTION OF ILLUSTRATIVE EMBODIMENTS

U.S. patent application Ser. No. 11/185,527, filed Jul. 20, 2005; 60/895,165, filed Mar. 16, 2007; and “Improved Process for Efficient Energy Recovery from Biomass,” filed concurrently herewith, are hereby incorporated herein by reference.

In one embodiment, the present invention relates to a process including steeping cereal kernels in an aqueous liquid, producing softened cereal; milling the softened cereal, producing a milled cereal comprising germ, protein, starch, and fiber; separating at least some of at least one material selected from the group consisting of germ, starch, and protein from the milled cereal, producing at least one of germ, starch, and a first protein portion, and also producing a first fiber portion that comprises fiber and starch, and a light steep water that comprises protein; and burning at least some of the fiber, producing a flue gas and a first quantity of energy; wherein the process further comprises at least one step selected from the group consisting of least partially powering at least one previous step with the first quantity of energy; and drying at least one separated material selected from the group consisting of germ, starch, protein, and saccharides with the flue gas, producing a dried separated material and a dryer exhaust.

Any cereal can be steeped. In one embodiment, the cereal is selected from the group consisting of corn and wheat. If the cereal is corn, a variety of types of corn can be used, including dent, high amylose and waxy corn.

The aqueous liquid is generally water, to which sulfur dioxide may be added to aid in softening. The product of the steeping step is softened cereal.

The softened cereal is thereafter milled. Milling can comprise one or more milling, grinding, or crushing steps. In one embodiment, milling comprises three milling steps on progressively finer mills. Milling produces a milled cereal comprising germ, protein, starch, and fiber. Milling can be as described in U.S. patent application Ser. No. 11/185,527.

At least some of at least one material selected from the group consisting of germ, starch, and protein is separated from the milled cereal by any appropriate technique, producing at least one of germ, starch, and a first protein portion. Germ can be used as a source of foodstuffs, cereal oil, or a combination thereof. Starch can be used as a source of dextrose or fructose for foodstuffs, as a source of ethanol fermentation feedstocks, as a source of biogas digestion feedstocks, or a combination thereof. In one embodiment, the process further comprises converting at least some of the starch to saccharides and fermenting at least some of the saccharides, producing ethanol, anaerobically digesting at least some of the saccharides, producing biogas, or a combination thereof. The first protein portion can be used as a source of foodstuffs, a raw material for industrial processes, or a combination thereof.

Also, some residual starch will typically remain in a first fiber portion that comprises fiber and starch, and some residual protein will remain in a light steep water that comprises protein.

Liquefaction and saccharification can be performed on any starch portion, such as at least some of the starch from the separating step, the first fiber portion, or both.

The separated products will typically have a water content in excess of that desired for typical uses thereof. The separated products can be dried by any appropriate technique, of which an exemplary one will be described below, prior to other processing steps or use.

In another step, at least some protein can be separated from the light steep water, producing a second protein portion and a process water that comprises low molecular weight protein. Separation of protein from light steep water is discussed in U.S. Pat. No. 5,773,076. In one embodiment, separating at least some protein from the light steep water comprises filtration of the light steep water. In a further embodiment, separating at least some protein from the light steep water comprises membrane filtration (typically, ultra- or microfiltration depending on desired molecular weight cutoff point) of the light steep water. Filtration and membrane filtration can be performed according to techniques known in the art. Generally, filtration or membrane filtration will yield a retentate (the second protein portion) and a permeate (the process water that comprises protein, generally low-molecular weight protein).

Some starch may also be present in the light steep water. In one embodiment, the starch in the light steep water is converted by liquefaction/saccharification before filtration, to avoid membrane fouling by long chain starch molecules. Starch saccharification, yielding saccharides, can be performed prior to separating saccharides from the protein, yielding a fourth protein portion.

The second protein portion can be further handled similarly to the first protein portion discussed above. The residual protein in the process water can be further processed as will be described below.

Turning to the first fiber portion, it is generally desirable to extract residual starch, a relatively high value material, from the fiber, a relatively low value material. At least some of the starch in the first fiber portion can be converted to saccharides, which can be performed using known techniques, such as use of amylase enzymes, acidic conditions, or a combination thereof. “Saccharides” is used herein to refer saccharide monomers, dimers, trimers, tetramers, or pentamers. As conversion proceeds, the viscosity of the first fiber portion will generally decrease. Conversion conditions can be selected by the operator in view of the desired level of starch extraction, the desired mix of saccharides (e.g., whether it is desired to convert starch to dextrose and fructose, or to other materials), and other parameters apparent to the skilled artisan.

At least some of the saccharides from the first fiber portion can be separated by any appropriate technique, producing saccharides and a second fiber portion that comprises fiber. The second fiber portion may contain some residual starch or saccharides, but preferably only a small amount.

In one embodiment, separating at least some starch or saccharides from a composition containing fiber, protein, or both can comprise filtration, such as membrane filtration, yielding a starch portion or saccharides. Also, at least some of the protein, if any, present in the composition can be separated from the fiber portion, if any, to yield a protein portion. Generally, in filtration, the permeate will be enriched in hydrolyzed starch or saccharides and the retentate will be enriched in protein. The hydrolyzed starch portion can be used as-is, saccharified, or processed in any other way known to the art. Saccharides can be processed as described elsewhere herein. The third protein portion can be processed similarly to a protein portion referred to above, including being combined with a previous portion for processing or use.

The saccharides separated from the first fiber portion can be further processed to yield dextrose or fructose for foodstuffs, can be used as a feedstock for ethanol fermentation, or a combination thereof. In one embodiment, the process further comprises fermenting at least some of the saccharides, producing ethanol.

In one embodiment, the second fiber portion can be washed. Washing can comprise contacting the second fiber portion with water or steam. In one embodiment, the second fiber can be washed with the recovered process water from the filtration of light steep water. Washing can remove residual amounts of protein and ash (inorganic ions, such as phosphates, among others) from the second fiber portion. Washing can render the second fiber portion more suitable for burning by removing materials that tend to slag the interior of combustion chambers.

It is also possible, depending on economic and other factors, to not extract starch or protein from the first fiber portion. At least some of either or both fiber portions can be used as an animal feed, either alone or in combination with a protein portion.

At least some of the fiber from the second fiber portion is burnt, producing a flue gas and a first quantity of energy. In one embodiment, burning can be conducted according to the teachings of United States patent application entitled “Improved Process for Efficient Energy Recovery from Biomass.”

The first quantity of energy can be captured by any appropriate technique, such as heat transfer from the combustion chamber to a working fluid, such as water or air. The flue gas is typically at a temperature notably higher than ambient temperature, e.g., from about 400° F. to about 750° F.

In one embodiment, burning further comprises burning at least a portion of the second fiber portion. Depending on the energy requirements of the process and economics the operator may chose to burn the first portion of fiber directly.

The process further comprises at least one step selected from the group consisting of at least partially powering at least one previous step with the first quantity of energy; and drying at least one separated material selected from the group consisting of the germ, the starch, the first protein portion, the second fiber portion, and the saccharides with the flue gas, producing a dried separated material and a dryer exhaust.

At least partially powering at least one previous step with the first quantity of energy can be performed by any appropriate technique. A working fluid which has captured at least part of the first quantity of energy can be used to provide heat to other steps, or can be used to produce electricity by, e.g., working a turbine or piston. At least partially powering at least one previous step with the first quantity of energy allows the process to be performed with a reduced input of external energy, e.g., from fossil fuels (either directly or as inputs to electricity generation) or distantly-generated electricity (with attendant energy loss on transmission).

In one embodiment, at least partially powering at least one previous step comprises heating an oil with the first quantity of energy, producing a hot oil, and circulating the hot oil to an apparatus wherein the at least one previous step is performed.

In one embodiment, at least partially powering at least one previous step comprises heating an oil with the first quantity of energy, producing a hot oil, and contacting an apparatus containing water or a mixture of air and water with the hot oil. Contacting water ladened stream with the hot oil will typically be performed across a pipe wall or other heat-conducting material separating the water from the hot oil.

Drying at least one separated material with the flue gas can be performed by any appropriate technique and for a duration and under conditions determinable by the skilled artisan as a matter of routine experimentation. Depending on the flue gas, the separated material, and the desired properties of the dried material (e.g., its desired moisture content), the flue gas may be cooled (from which energy can be extracted), heated, humidified, or dehumidified between burning the fiber and drying the at least one separated material. The result of drying is a dried separated material (meaning a material having a lower moisture content than the material prior to the drying step) and a dryer exhaust. The dryer exhaust will typically be cooler and higher in humidity than the flue gas. The dryer exhaust can be scrubbed, if need be, and vented to atmosphere, or it can be fed to other steps of the process that can use the dryer exhaust as an input gas.

In one embodiment, converting at least some of the starch in the first fiber portion to saccharides comprises contacting the first fiber portion with the dryer exhaust. The dryer exhaust in this application will generally contain a superheated gas with predominately entrained water vapor and minimal air from the drying step at a pressure from 0 to 1 bar gauge.

In one embodiment, the process further comprises digesting anaerobically the soluble organics from the BSB membrane separation process, or from the process water remaining from the LSW membrane process if not fully utilized to wash second fibers, producing a biogas and a process water essentially depleted of organics. Anaerobic digestion refers to the metabolism of the solule organics by microorganisms in a substantially anoxic environment. “Biogas” refers to a compound containing carbon (other than CO₂) that is a gas at ambient temperature and pressure. The biogas produced by this step generally contains a notable fraction of methane, among other possible materials.

In one embodiment, the process further comprises digesting anaerobically at least some saccharides, producing a biogas and a process water essentially depleted of organics.

In one embodiment, the process further comprises digesting aerobically at least some saccharides, producing a yeast biomass. The yeast biomass is enriched in protein relative to the saccharides stream, and the yeast biomass can be further processed similarly to any previous protein portion.

As will be apparent to the skilled artisan, biogas has an energy content that can be extracted by combustion. In one embodiment, the process further comprises burning the biogas to produce a second quantity of energy and at least partially powering at least one previous step with the second quantity of energy. Burning can make use of any technique known in the art, and energy can be extracted by any appropriate technique, such as are described above. At least partially powering at least one previous step can be as described above regarding the first quantity of energy.

In addition to the separated materials, energy, and biogas, if any, the process will generate waste streams. Waste gas, such as gas containing CO₂, can be scrubbed of undesirable emissions, such as hydrogen sulfide and vented to the atmosphere. The depleted process water, such as water containing inorganic ions and nitrogen, can be recovered as wash water for second fiber, evaporated to concentrate the inorganics for incorporation in animal foodstuffs or undergo removal of the ions and nitrogen by any appropriate technique and other abatement steps required for use or release of the water. In one embodiment, the process further comprises removing at least some phosphorous and at least some nitrogen from the final waste water by converting phosphorous and nitrogen to struvite, such as are described by U.S. Patent Application Ser. No. 60/895,165.

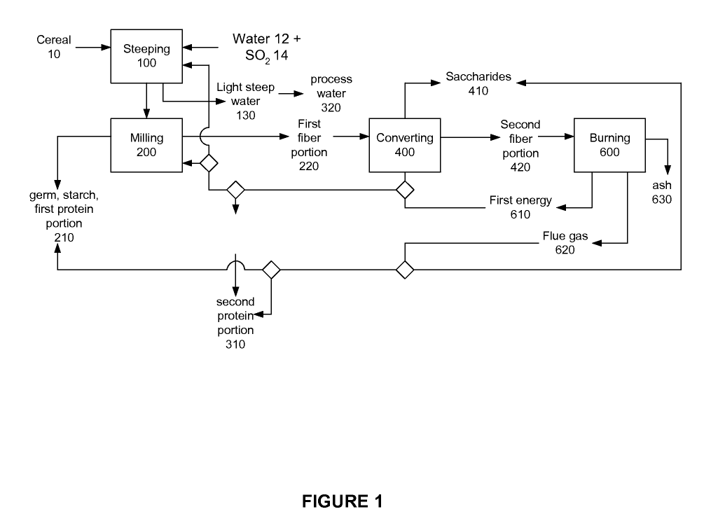

Turning to the figures, FIG. 1 shows one embodiment of the present invention. In this embodiment, corn is separated and processed into germ, protein, starch, ethanol, and fiber.

The feed 10 to the process is a cereal, such as corn or wheat. The cereal is fed into a steep tank, along with water 12 and, typically but optionally, sulfur dioxide 14, and steeping 100 occurs. Steeping 100 is either batch or continuous and the residence time of the cereal in the steep tank is from 12 to 48 hours. The temperature during steeping 100 is in the range 45° C. to 55° C. (113° F.-131° F.). The products of the steeping step 100 are softened cereal and a liquid fraction called steep liquor or light steep water 130. The light steep water 130 can be filtered (e.g., using filtration or membrane filtration) to produce a clear permeate stream free of suspended solids (process water 320, containing residual protein) and a protein rich retentate stream (second protein portion 310) that can be used as an animal feed or for other purposes.

The softened cereal is then milled 200. Milling 200 can comprise a first, relatively coarse milling, allowing the germ to be separated from the rest of the kernel. The germ is dried and oil can be removed from the germ and refined to make a vegetable oil. The remaining germ meal can be used as an ingredient in gluten feed or as a co-fuel with the first fiber fraction or the second fiber fraction.

After the majority of the germ is removed, the remainder of the kernel can undergo a second milling, which is finer than the first, to pulverize endosperm particles in the cereal kernels while leaving the fibrous material nearly intact. Any residual germ can be recovered and the second milled cereal can then be passed through a screen to separate it into a fiber portion, starch, and protein. The fiber portion comprises fiber, starch, and protein. The fiber portion can then be milled a third time. The relatively finely milled fiber material produced by the third milling can then be screened and washed with water or a recycled aqueous process stream, to separate residual starch and protein from the fiber. This step produces a first fiber portion 220, starch, and protein. The first fiber portion 220 comprises fiber and starch. One or more of the germ, starch, and first protein portion generated by the milling step can be separated to yield one or more products 210.

Separation can include combination of starch and protein fractions from the second and third millings, followed by a separation operation, for example by centrifugation, to produce the first protein portion and starch. The starch can be washed to further purify it. The resulting starch can be dried to produce cereal starch, or can undergo further processing. For example, the starch can be hydrolyzed to produce dextrose, which can in turn be used in fermentation to produce ethanol or organic acids, or the dextrose can be converted by enzymatic treatment to high fructose cereal syrup.

In some embodiments of the process, if the yield of protein from the third milled fiber is not considered important, this screening step can be eliminated. More usually, the number of fiber wash screens can be as few as three. Similarly, the amount of wash water (or other aqueous process stream used for this purpose) can also be reduced. The first fiber portion 220 after washing can contain, in some embodiments of the process, 15-60 wt % starch on a dry solids basis (d.s.b.).

The first fiber portion 220, which as mentioned above still contains a significant amount of starch, is then gelatinized in a starch cooker for the starch converting step 400. However optionally another source of starch can be added at this point, and if necessary diluted with a low solids recycle process steam or water to bring the dry fermentable solids into the range of 15 to 35%, preferably 25%. The reason for adding another starch stream will depend on the quantity of either dextrose or ethanol required from the process. Before cooking begins, the pH of the material can be adjusted to about 4.0-6.0 and alpha amylase can be added. In one embodiment, the pH of the material can be adjusted to about 4.5-5.6. In one embodiment, the pH of the material can be adjusted to about 4.0-5.0. Preferably, the alpha-amylase is active at the adjusted pH. In one embodiment, the alpha amylase is Fuelzyme™-LF (Verenium Corporation, Cambridge, Mass.). Information relating to Fuelzyme-LF is provided by Richardson, et al., J. Biol. Chem. 277:26501-26507 (2002).

Preferably the moisture content is adjusted prior to or during the cooking step such that the dry fermentable solids content is about 15-35%, preferably about 25% by using water, preferably process waters. A number of suitable starch cookers are known in the industry, such as jet cookers or vapor cookers. We have found vapor cooker to enable use of low pressure vapors typically in the range of 10 psia to 50 psig. Typical temperatures for the starch cooking step are 70° C. to 110° C. (158-230° F.). The residence time in the cooker can vary, but in many cases will be about 5-10 minutes. The product from the cooker can then be held in liquefaction tanks, for example for about 2-3 hours, to allow liquefaction of the starch by the alpha amylase to proceed.

The temperature of the liquefied material is then reduced to about 60° C., the pH adjusted (if necessary) to 4.0-4.5, such as to about 4.2, and amyloglucosidase enzyme is added. The liquefied material can be held for about 2 to 10 hours to allow saccharification to start and the viscosity to be reduced. This partially-saccharified slurry is then screened to remove a second fiber portion 420. This can be done in a number of stages, using water or a suitable recycled aqueous process stream to wash the saccharides from the fiber in a counter-current manner. This water or recycled stream can be added in the final screen if low in fermentables or can be used in combinations with process water streams containing fermentables being used in earlier stages depending on their fermentable content, with the wash water then progressing to the first screen. Suitable types of screens include DSM screens and centrifugal screens. The number of screen stages can vary from 1-7, based on the recovery requirements.

The second fiber portion 420 can be pressed, for example in a screw press, and then dried and milled in preparation for the burning step 600.

The saccharides 410 from the screens can be fermented to produce ethanol. The saccharides 410 can be placed in a fermenter with a microorganism that can produce ethanol. Suitable microorganisms for this purpose include Saccharomyces cerevisiae, Saccharomyces carlsbergiensis, Kluyveromyces lactis, Kluyveromyces fragilis, or any other microorganism that makes ethanol. Additional amyloglucosidase enzyme may be added, but residual amyloglucosidase enzyme from the converting step 400 is often sufficient to continue saccharification during fermentation. In one embodiment, the pH is adjusted to about 4 and the temperature adjusted to about 28° C. As a result of the fermentation, most or all of the dextrose in the saccharides 410 is converted to ethanol, CO2, yeast biomass, and a variety of organic materials such as glycerol. The ethanol can be separated from the fermentation broth in a distillation unit. Suitable distillation temperatures can be about 60-120° C. Optionally, the ethanol can then be subjected to rectification and dehydration to produce a fuel-grade ethanol product. Another option is to produce potable ethanol by rectification.

The distillation also produces a stream that is typically referred to as beer still bottoms. The soluble fraction of beer still bottoms can be used as a process water and the insoluble fraction can be used either as an animal feed or feed to a burning step (600) as fuel.

In the burning step 600, the second fiber portion is burnt, typically in a suspension burner, and energy extracted, typically through heat transfer to a water wall, yielding first energy 610, and generation of a flue gas 620 at a temperature greater than ambient.

The first energy 610 can then be directed to one or more previous steps in the process, such as converting 400, milling 200, steeping 100, or separations performed after such steps. The flue gas 620 can be used for drying one or more materials, such as germ, starch, or first protein portion 210, second fiber portion 310, or saccharides 410.

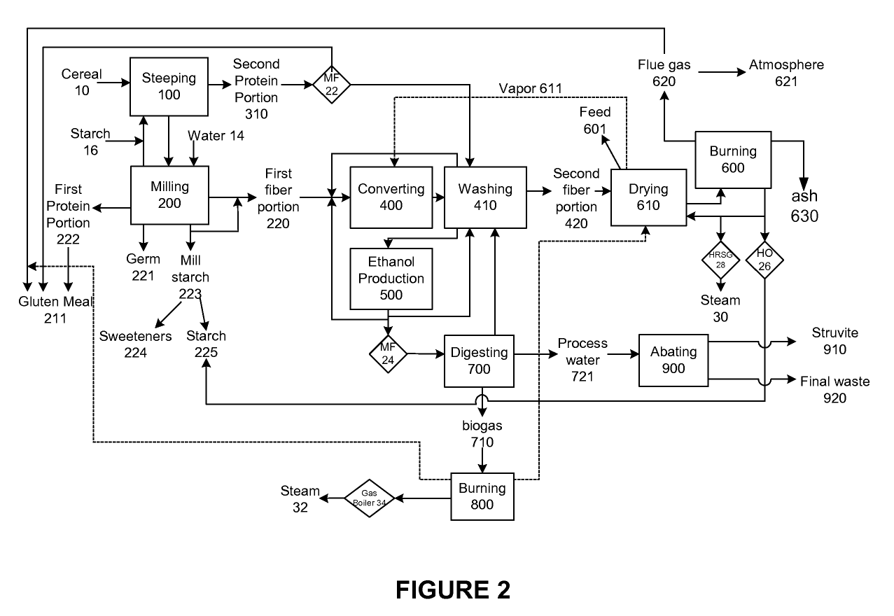

In another embodiment, shown in FIG. 2, one or more of the germ 221 and first protein portion 222 generated by the milling step 200 can be separated to yield gluten meal 211. The milled starch 223 can be processed to yield sweeteners (e.g., dextrose or fructose) 224, starch 225, or both.

The second protein portion 310 can be subjected to membrane filtration 22, with recovered protein fed to gluten meal 211, and permeate water used as a process water in a washing step 410.

The first fiber portion 220 can be partially converted 400 to yield hydrolyzed starch as described above, with the hydrolyzed starch and the second fiber portion 420 separated in a washing step 410. The second fiber portion 420 can be pressed, for example in a screw press, and then dried 610 and milled in preparation for the burning step 600 (or, after drying, sent off for use as animal feed 601, or a combination thereof). The vapor 611 generated by drying can be sent as a process stream to the starch converting step 400.

In the burning step 600, the second fiber portion is burnt, typically in a suspension burner, yielding energy which can be recovered by a hot oil vessel 26 or a heat recovery steam generator 28, the latter yielding steam 30 which can be used as a process stream or for electricity generation. Burning 600 also generates a flue gas 620 at a temperature greater than ambient. The flue gas 620 can be used to dry a product, such as gluten meal 211, vented to atmosphere 621, or a combination thereof.

The ethanol production step 500 yields bottoms that can be separated by a membrane filtration unit 24, with digestible insolubles digested 700 to yield biogas 710, which can be burnt 800 as described above. A gas boiler 34 can be used to capture energy from burning 800 to generate steam 32. The process water 721 from digesting 700 can be abated 900 of nitrogen and phosphorous by the generation of struvite 910 and a final waste water 920 which can be further processed or discharged, as desired.

The processes of the present invention can be performed on a batch, semi-batch, or continuous basis, or some combination thereof. For example, certain steps can be performed on a batch basis while other steps are performed continuously in the same process.

Certain embodiments of the process of the present invention provide a greater yield of dextrose or ethanol than a conventional cereal wet milling process. In comparison to a dry milling process which produces ethanol, certain embodiments of the present process achieve a similar yield of ethanol but provide a better yield of germ and protein, similar to that achieved in conventional wet milling processes.

The extraction of energy from fiber burning or biogas burning reduces external energy inputs, thus yielding a more carbon-neutral milling process than previously known. Also, this process allows the recovery of ash-based products which may be variously used as fertilizer additives, land application materials, cement additives, or in other uses. The process disclosed thus generates sustainable co-products in a novel way.

### EXAMPLE 1

500 g of fiber mash were pH adjusted from 4.02 to 4.54 pH using 40% NaOH (0.58 g). 0.06 wt % of Fuelzyme™-LF (Verenium Corporation, Cambridge, Mass.) (0.09 g) were added to the mix, and the mixture was agitated and heated to 100° C. The mixture was agitated at this temperature for 90 minutes, then cooled to 62° C., at which point the pH was adjusted to 4.2 with sulfuric acid and 0.1 g glucoamylase enzyme was added. The mixture was left stirring under these conditions for about 16 hr; samples were taken for sugar analysis at 6 hr and 16 hr.

The above procedure was repeated with an alpha amylase liquefaction enzyme most active at about pH 5.6 (Novozymes, Bagsvaerd, Denmark), but in this case the initial pH adjustment was from 3.8 to 5.6 (using correspondingly more 40% NaOH (1.21 g)). Correspondingly more sulfuric acid was required to reduce the pH back down to 4.2 for the saccharification stage.

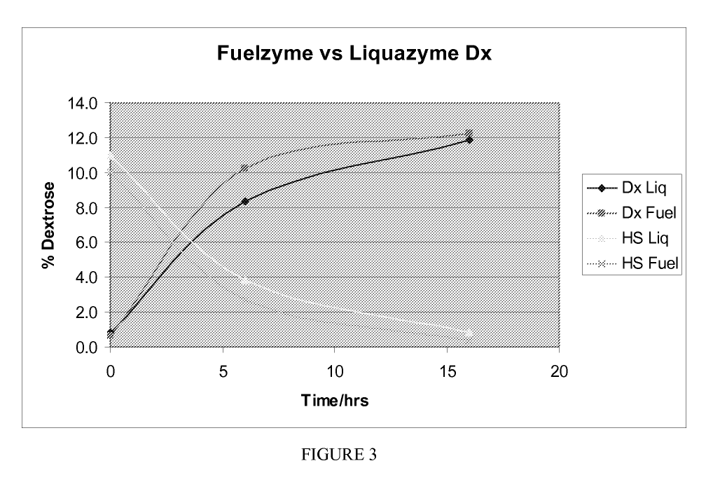

The results shown in FIG. 3 indicate that the Fuelzyme enzyme gives a good yield of dextrose very rapidly (10% Dx on sample basis after 6 hr vs about 8% Dx for the standard enzyme). After 16 hr the difference between the two enzymes is smaller but still significant. Corresponding changes in the concentrations of Higher Sugars (HS) are also seen.

### EXAMPLE 2

Experiments similar to those described under Example 1 were completed on Light Steep Water (LSW) with similar observations.

What is claimed is:

1. A process comprising:
steeping cereal kernels in an aqueous liquid, producing softened cereal;
milling the softened cereal, producing a milled cereal comprising germ, protein, starch, and fiber;
separating at least some of at least one material selected from the group consisting of germ, starch, and protein from the milled cereal, producing at least one of germ, starch, and a first protein portion, and also producing a first fiber portion that comprises fiber and starch, and a light steep water that comprises protein; and
burning at least some of the fiber, producing a flue gas and a first quantity of energy;
wherein the process further comprises at least one step selected from the group consisting of least partially powering at least one previous step with the first quantity of energy; and drying at least one separated material selected from the group consisting of germ, starch, protein, and saccharides with the flue gas, producing a dried separated material and a dryer exhaust.

2. The process of claim 1, further comprising:
separating at least some protein from the light steep water, producing a second protein portion and a process water that comprises protein.

3. The process of claim 2, further comprising:
combining the second protein portion with a previous protein portion.

4. The process of claim 1, further comprising:
converting at least some of the starch from the separating step, the first fiber portion, or both to saccharides.

5. The process of claim 4, wherein converting comprises adjusting the pH of the starch or the first fiber portion to a pH from about 4.0 to about 5.0 and contacting the starch or the first fiber portion with an alpha-amylase active at the pH from about 4.0 to about 5.0.

6. The process of claim 4, further comprising:
separating at least some of the saccharides from the first fiber portion, producing saccharides and a second fiber portion that comprises fiber, wherein at least some of the second fiber portion is burned in the burning step.

7. The process of claim 6, further comprising:
fermenting at least some of the saccharides, producing ethanol.

8. The process of claim 6, further comprising:
digesting anaerobically at least some of the saccharides, producing a biogas and a final waste water.

9. The process of claim 6, wherein separating the saccharides is by filtration, and further comprising separating at least some of the protein from the first fiber portion by filtration, to yield a third protein portion.

10. The process of claim 9, further comprising:
combining the third protein portion with a previous protein portion.

11. The process of claim 1, wherein the light steep water further comprises starch and protein, further comprising:
converting at least some of the starch in the light steep water to saccharides;
separating by filtration the saccharides and the protein from the light steep water, to yield a fourth protein portion.

12. The process of claim 11, further comprising:
digesting aerobically at least some of the saccharides, producing yeast biomass.

13. The process of claim 12, further comprising:
combining the yeast biomass with a previous protein portion.

14. The process of claim 11, further comprising:
digesting anaerobically at least some of the saccharides, producing a biogas and a final waste water.

15. The process of claim 14, further comprising burning the biogas to produce a second quantity of energy and at least partially powering at least one previous step with the second quantity of energy.

16. The process of claim 11, further comprising:
combining the fourth protein portion with a previous protein portion.

17. The process of claim 2, further comprising digesting anaerobically biologically available organic residues from the process water, producing a biogas and a final waste water.

18. The process of claim 17, further comprising burning the biogas to produce a second quantity of energy and at least partially powering at least one previous step with the second quantity of energy.

19. The process of claim 17, further comprising removing at least some phosphorous and at least some nitrogen from the final waste water by converting phosphorous and nitrogen to struvite.

20. The process of claim 1, wherein the burning step results in an ash which can be used as a material selected from the group consisting of fertilizer additives, land application materials, and cement additives.
